(19) United States
(12) Patent Application Publication
(10) Pub. No.: US 2009/0234465 A1
(43) Pub. Date: Sep. 17, 2009

(54) Method for safely operating an automation technology field device

(75) Inventor: Klaus Korsten, Steinen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Process Solutions AG, Reinach (CH)

(21) Appl. No.: 11/886,125

(22) PCT Filed: Mar. 14, 2006
(86) PCT No.: PCT/EP2006/060710

§ 371 Date: Jun. 11, 2008

(30) Foreign Application Priority Data
Mar. 23, 2005 (DE) 10 2005 014 050.5

(51) Int. Cl. G05B 15/00

(52) U.S. Cl. 700/17

(57) ABSTRACT

In a method for safe servicing of a field device of automation technology, wherein the field device is connectable with a service unit via a communication connection, following invocation of a device description file belonging to the field device, a security program associated with the device description file is executed. The safety program includes request for a user identifier. In accordance with the entered user identifier, certain device functionalities are enabled.

The invention relates to a method for safe servicing of a field device of automation technology.

In automation technology, both process automation and factory automation, field devices are often installed, where they serve for registering and/or influencing variables. Examples of such field devices are fill level measuring devices, mass flow measuring devices, pressure and temperature measuring devices, pH- and redox-potential-measuring devices, conductivity measuring devices, etc., as used in process automation technology for registering, as sensors, the corresponding process variables, fill level, flow, e.g. flow rate, pressure, temperature, pH-value and conductivity value, respectively.

In factory automation, in contrast, frequency control devices, motor starters, servomotors, as well as safety systems for protection of humans and/or machines, are used

Besides pure measuring devices, systems are also known for fulfilling yet additional tasks. Mentionable here are electrode cleaning systems, calibration systems, as well as samplers, as used in the process industry.

Serving for influencing variables in a factory automation application are motors, for example, whose speed can be set via a frequency-control device.

Serving for influencing variables in a process application are actuators, e.g. valves, which control flow of a liquid in a section of pipeline, or pumps, which permit the changing of fill level in a container.

A large number of such field devices are manufactured and sold by the firm, Endress+Hauser®).

Frequently, field devices are connected via a fieldbus (Profibus®, Foundation® Fieldbus, HART®, etc.) with superordinated units, e.g. control systems or control units. These superordinated units serve for process control, process visualization, process monitoring or process-near, asset management.

For servicing field devices, corresponding service programs (operating tools) are needed. These service programs can run self-sufficiently (Endress+Hauser FieldCare, Pactware, AMS, PDM) or can also be integrated in control system applications (Siemens Step7, ABB Symphony, PCS7, PRN Viewer, AMSinside).

Servicing of field devices is possible with conventional device descriptions (Device Descriptions DDs or Electronic Device Descriptions EDDs) used often in process automation technology.

For a comprehensive servicing of field devices, inclusive of all functions, including graphical service elements and stored calculations, such as e.g. a linearizing table for the relationship between fill level and volume of a tank, these functions must be made known to the service program (operating tool).

The FDT-specifications, serving as an industry standard, were developed by the PNO (Profibus Nutzer Organisation (Profibus User Organization)) in cooperation with ZVEI (Zentralverband Elektrotechnik- und Elektroindustrie (The German Electrical and Electronics Industry, a registered association)). The current FDT-Specification 1.2.1, including the Addendum for Foundation Fieldbus communication, is available from ZVEI, PNO or the FDT-JIG (Joint Interest Group). It must be contemplated that other types of communication will need to be supported in the coming years; among these will belong Interbus S, DeviceNet of ODVA and AS Interface. Additionally to be considered here are communication protocols, such as SERCOS and a number of company-specific protocols.

Many device manufacturers deliver, therefore, files for both types of device description. The more comfortable type of servicing is provided by the field-device-associated device drivers called DTMs (device type manager). These DTMs encapsulate all data and functions of the particular field device and simultaneously provide a graphical user interface.

With the help of these device drivers, a field-device servicing encompassing field devices of various manufacturers is possible using appropriate service programs.

The DTM device drivers require, as runtime environment, a frame application (FDT-frame application). They enable, among other things, access to different data of the field devices (e.g. device parameters, measured values, diagnostic information, status information, etc.), as well as the calling of special functions associated with individual device drivers.

Frame application and device driver DTM work according to the client-server principle.

DDs or EDDs require, in contrast, an interpreter, since these are not per se self-sufficiently run-capable software components.

Frequently, field devices are integrated in safety-critical operations, especially in chemical plants of the process industry or in robot-controlled plants. Changes in the settings of the individual field devices can have significant effects as regards safety. Responsible plant operators must, therefore, make sure that only trained personnel can adjust field device settings. In principle, there are two possibilities for changing settings of a field device by targeted parameter access.

A first possibility is that the service person finds the field device and enters parameters directly at the field device via a keypad or keyboard.

Another possibility is remote access via a bus system. For this, a service unit with an appropriate operating tool is required. These operating tools can, in turn, run on permanently installed computers, in a control room or also on a portable computer (e.g. laptop). These computers communicate via a protocol with the field device and, by input on the service unit, the appropriate parameters in the field device are changed.

The following access limitations (security checks) are known for these two possibilities. Request of a security code at the field device directly, or request of a security code at the service unit.

Request of the security code at the service unit can occur on different levels, for instance at the system level, i.e. such can transpire already at login to the service unit. Or, the request can be made at the program level, i.e. when the relevant service program is started.

At the system level, issuance of different security codes is possible, for example corresponding to administrator rights or simple user rights. In this way, booting of the system can be prevented.

Such a differentiating is also possible on the program level. Only certain users can then start the relevant program, the service program. Following start of the service program, normally, the user can access all parameters of a field device and, thus, also change these. Generally, issuance of access rights in the case of computer systems is managed in so-called user rolls.

Frequently, the parameters of a field device are not all equally critical. There are gradations between different categories of parameters. Highly critical parameters are permitted to be changed, however, only by appropriately schooled personnel. Less critical parameters can be set by normal service personnel. The following example illustrates this.

If the schooling of a measurement- and control-systems technician is limited to the Profibus bus system and special pressure measuring devices, then this person should not be permitted access to pressure devices of another bus system (e.g. Foundation Fieldbus), or other device types.

With the previously known protection mechanisms, a differentiated access protection has not been possible for field devices of process automation technology. For a larger plant, this means a significant security effort, which, naturally, complicates the auditability. In an auditing, a review is made, whether SOPs (service operating procedures) are being observed.

An object of the invention is, therefore, to provide a method for servicing a field device of automation technology, which method overcomes the aforementioned disadvantages and, especially, makes possible safe and simple access to individual field devices.

This object is achieved by the method defined in claim 1. Advantageous further developments of the invention are given in the dependent claims.

An essential idea of the invention is to associate with a device driver file for a field device, which device driver describes the functionality of the field device, additionally a security check, which controls person-specific access to a field device or to individual parameters or functionalities of the field device.

In a further development of the invention, the user roll can be inherited by the device driver file from the service program. In this way, access rights can be easily forwarded.

In a special embodiment of the invention, the user roll can be stored in the device driver file. This enables a simple associating of user roll and device driver file.

The device driver file can be, for example, a DTM or DD/EDD.

With the help of the method of the invention also a simple and safe offline servicing of field devices is possible. Parameter changes, also in the case of offline-servicing of field devices, are only possible with appropriate authorization.

The invention will now be explained in greater detail on the basis of an example of an embodiment presented in the drawing, the figures of which show as follows:

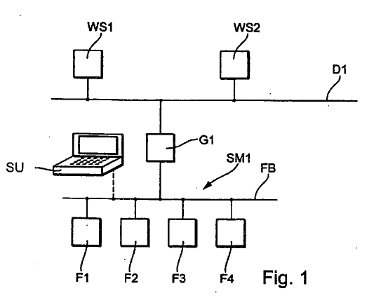

FIG. 1 schematic representation of a process automation technology network with a plurality of field devices;

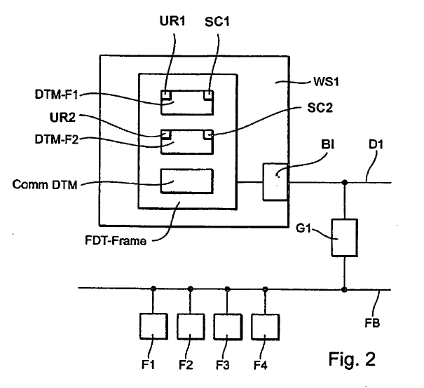

FIG. 2 schematic representation of a conventional communication connection between a service program and a plurality of field devices; and

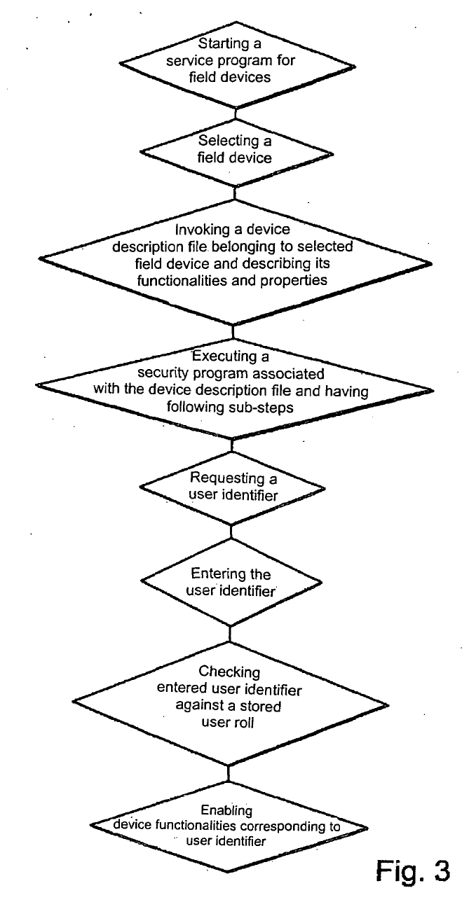

FIG. 3 flow diagram for the method of the invention.

FIG. 1 shows details of a communication network of process automation technology. Connected to a data bus D1 is a plurality of computer units (workstations) WS1, WS2. These computer units can serve as superordinated units (control system or control unit) for process visualization, process monitoring and for engineering, and also for servicing and monitoring of field devices. Data bus D1 works e.g. according to the Profibus® DP-standard or the HSE (High Speed Ethernet) standard of Foundation® Fieldbus. Via a gateway G1, which is also referred to as a linking device or segment coupler, data bus D1 is connected with a fieldbus segment SM1. Fieldbus segment SM1 is composed of a plurality of field devices F1, F2, F3, F4, which are connected together via a fieldbus FB. The field devices F1, F2, F3, F4 can be both sensors or actuators. Fieldbus FB works according to one of the known fieldbus standards Profibus, Foundation Fieldbus or HART. Temporarily connected with fieldbus FB is a portable computer unit SU.

FIG. 2 shows schematically a service program, which can run on one of the control units WS1, WS2, or on the service unit SE. The service program can be e.g. the service software PACTware (PACTware Consortium e.V.) or FieldCare® (of the firm, Endress+Hauser®), which both require the operating system Microsoft Windows®, 98NT, 2000 and which serve as FDT frame application. The frame application FDT-frame is responsible, in particular, for managing the device driver DTM in a project data base, for communication to the bus systems and for managing the device catalog.

Implemented in the frame application FDT-frame are device drivers e.g. for the field devices. For purposes of illustration, only two device-DTMs, DTM-F1 DTM-F2, together with one communication DTM, Comm DTM, are shown. For example, device-DTM, DTM-F1, encapsulates the data and functions of the field device F1. DTM-F1 requires the FDT-frame application as its runtime environment.

With the help of the device driver DTMs, a combined servicing of the field devices of various manufacturers, as well as an establishing of a communication connection between the computer unit WS1 and the field device is F1, F2, F3, F4 are possible. Thus, the device driver DTM-F1 permits access to various pieces of information in the field device F1, such as device parameters, device configuration, downloading of diagnostic data and status information, via a manufacturer-specific, graphical user.

The FDT concept is based on integrating, in simple manner, different field devices of different manufacturers into one FDT frame application via the corresponding device DTMs.

In terms of hardware, the connection to the field device F1 is established via a bus interface BI, the data bus D1, the gateway G1, and the fieldbus FB.

The according to the invention, stored in the device driver DTM-F1 are a security check SC1 and a user roll UR1. In like manner, stored in device driver DTM-F2 are a security check SC2 and a user roll UR2. By “user roll” is meant a register of persons and their respective authorizations (user rights).

The method of the invention will now be explained in greater detail on the basis of the flow diagram shown in FIG. 3. For servicing field device F1, which is connected via a fieldbus FB with a service unit SU1, the user first opens on the service unit SU1 a service program for field devices of various manufacturers, e.g. the program “FieldCare” of the firm, Endress+Hauser. Appearing on the screen of the service unit SU1 is a list of the field devices connected to the fieldbus.

By clicking one of the displayed field devices, that device is selected, in this example such being field device F1. The associated device driver file DTM-F1 is invoked, i.e. opened, loaded, or its file is accessed. Following invocation, a security program with the security check SC1 is started. The security check SC1 includes the following steps: Request for a user identifier UI; entry of the user identifier UI; comparing the entered identifier UI with the records of a user roll UR1. The device functionalities associated with the user identifier UI are enabled. In this way, it can be assured that only persons with a certain user identifier, e.g. appropriately schooled personnel, have access to parameters, respectively functionalities, of a field device.

With an appropriate user identifier, the user can make parameter changes and adjust settings. Thus, the user can change e.g. the limit values at which an alarm is produced.

Important here is that no communication channel is opened to the field device, until the correct identifier UI has been entered.

Unauthorized access to data in field devices can, in this way, be prevented.

The method of the invention is suited, besides for online servicing of field devices, in which a direct communication connection exists between service unit and field device, especially also for safe offline servicing of a field devices, where no direct communication connection with the field device can be established. Also offline parameter changes can only be performed by an appropriately authorized person.

The standard IEC 61508 SIL (safety integrity level) was especially developed for safety-critical applications in industrial automation. The purpose of this safety standard is to minimize industrial plant risk representing danger for humans and environment.

Thus, in the case of SIL applications, there can be targeted assurance that a person A with an user identifier UIA, who has received no SIL schooling, has no access to SIL-relevant parameters in the field device. A person B having a user identifier UIB and an appropriate SIL schooling can, in contrast, change the SIL-relevant parameters.

The invention is not limited to field devices serviceable via a device driver file DTM. It is, in principle, applicable for all known device descriptions, such as EDDL. Indeed, as already described, DDs/EDDs are not self-sufficient programs and are thus not able directly to the use or possess an access mechanism. However, it is possible, given a DD/EDD, to start programs which possess this capability and which can act in the same manner as above described. This opening of other programs can be effected with the help of so-called OCX or ActiveX commands.

The essential chain of events is, thus, the same for a DD/EDD application as for a solution with a DTM. The only differences lie in the fact that the DD/EDD invokes a separate security program and the separate security program must be adapted specially for the operating tool based on DDs, or EDDs.

In both cases, it is now possible to proceed based on the used safety directives of an enterprise, when access rights are not present. This can even include blocking of an authorization in the face of multiple erroneous entries of the user identifier.

A further advantage of the method offers the opportunity for inheritance of user rolls from higher levels. In this way, access rights can be transferred in simple manner. Thus, user rolls can be inherited by the device description file, or by a plurality of device description files, from the service program. The user roll can be stored in the device description file or in a separate file.

The security check can also involve a combination check, thus, for example, requested entry of a username plus a password for the user identifier.

The present invention enables, in simple manner, provision of access to the device functionalities of individual field devices only for defined persons or groups of persons. Access rights can be individually issued field-device-specifically right down to individual parameters and/or individual device functionalities. Possible examples here are the different parameter sets in field devices, e.g. diagnostic parameters, service parameters or alarm limits.

Thus, for example, a system administrator can on the basis of his or her user identification only change field device alarm parameters that are necessary for system control, not, however, parameters which have a direct influence on the measurement- or control-application.

The invention thus provides significantly increased operational safety in a plant. Changes of safety-critical parameters in field devices can only be made by persons possessing the appropriate authorization.

1-6. (canceled)

7. A method for the safe servicing of a field device of automation technology, wherein the field device is connectable with a service unit via a communication connection, comprising the steps of:
starting a service program for field devices;
selecting a field device;
invoking a device description file belonging to the selected field device and describing functionality and characteristics of the field device;
executing a security program associated with the device description file,
requesting a user identifier;
entering the user identifier;
checking the entered user identifier against a stored user roll; and
enabling device functionalities appropriate to the user identifier.

8. The method as claimed in claim 7, wherein:
the user roll is inherited by the device description file from the service program.

9. The method as claimed in claim 7, wherein:
the user roll is stored in the device description file.

10. The method as claimed in claim 7, wherein:
the user roll is stored in a separate file.

11. The method as claimed in claim 7, wherein:
servicing of the field device occurs offline.

12. The method as claimed in claim 7, wherein:
servicing of the field device occurs online.
